(19) United States
(12) Patent Application Publication
(10) Pub. No.: US 2009/0056138 A1
(43) Pub. Date: Mar. 5, 2009

(54) METHOD AND APPARATUS FOR SHAVING

(76) Inventor: Dan H. Stephens, Salt Lake City, UT (US)

Correspondence Address: BATEMAN IP LAW GROUP, P.O. BOX 1319, SALT LAKE CITY, UT, 84110, US

(21) Appl. No.: 12/200,796

(22) Filed: Aug. 28, 2008

Related U.S. Application Data
(60) Provisional application No. 60/969,354, filed on Aug. 31, 2007.

(51) Int. Cl. B26B 19/42; B23P 17/04

(52) U.S. Cl. 30/34.2; 29/401.1

(57) ABSTRACT

A method and apparatus for improving shaving includes a cutting head which is unbalanced so as to create generally circular movements in the screen. The movement allows hairs extending from the skin at different angles to be cut by the cutting head.

### RELATED APPLICATIONS

The present application claims the benefit of U.S. Provisional Application Ser. No. 60/969,354, filed Aug. 31, 2007, which is expressly incorporated herein by reference.

### BACKGROUND

1. Field of the Invention

The present invention relates to a method and apparatus for shaving. More particularly, the present invention relates to a method and apparatus for improving the shaving of a conventional electric razor by causing the cutting head to be unbalanced and thereby create additional vibrational energy in the cutting head.

2. State of the Art

Shaving is a common chore for both men and women to remove unwanted hair growth. There are a variety of different ways for removing hair growth. Many women utilize waxing or laser treatment for removal of unwanted hair. Most men and women rely on razors which are used periodically to remove the unwanted hair. While many people use a manual razor, such razors have several disadvantages. First, they require the use of shaving cream to avoid irritating the skin. Second, many people suffer minor cuts while shaving with a manual razor. Third, the razors or razor heads are generally disposable and become quite costly over a period of time.

Because of these disadvantages, many people prefer the use of an electric razor. The electric razor can be used without the necessity of shaving cream and can be powered by a small battery. Thus, many people will keep a small electric razor in a travel bag or in an automobile to remove any unwanted hair growth.

One popular electric shaver is the CLEANCUT razor made by Seiko, exemplified in FIG. 1. The shaver, generally indicated at 4, has a generally cylindrical body 8 with a screw-off end cap 10. The end cap 10 allows for the insertion and removal of a battery 12, which is used to power the razor 4.

The battery 12 is disposed in electrical communication with an electric motor 14 and a switch 16 which is disposed about the body 8. The switch 16 completes an electrical circuit so that the battery 12 powers the electric motor 14. Disposed above the electric motor 14 are a plurality of cutting blades 20. The cutting blades 20 extend upwardly from the motor 14 and form part of a single cutting head 22. The cutting head 22 is housed in a cap 24 which has a dome-shaped metal screen 26 at the top. The screen 26 is configured to be held against the user's skin. Any hair which extends through the screen 26 is cut by the cutting blades 20 of the cutting head 22 as the cutting head rotates about a shaft 28 extending from the electric motor 14. Over time, the area between the screen 26 and the cutting head 22 fills with small pieces of hair. The cap 24 is then removed and the cutting head is cleaned.

While such a cutting device has been found to be desirable, the cutting efficiency of the device can be improved.

### SUMMARY OF THE INVENTION

It is an object of the present invention to provide an improved electric razor.

The above and other objects of the present invention are achieved by using a cutting head which is rotationally unbalanced. The unbalanced cutting head creates vibrational energy in the cutting head as it cuts, causing minor movements in the electric shaver. It has been found that the vibration of the electric shaver improves its ability to cut hair. Specifically, the vibration of the shaver causes small movements in the screen. This allows hairs extending from the skin at different angles to more easily pass through the screen and thereby contact the cutting blades.

In accordance with one aspect of the invention the unbalanced cutting head is obtained by placing a weight on the cutting head. The weight may be relatively small such as between 1 and 3 grams. It will be appreciated that the further the weight is placed from the shaft about which the cutting head rotates, the smaller the weight needs to be to create adequate vibration of the razor.

The use of a weight may be achieved, for example, by placing the head of a screw or a small metal weight on the cutting head. As the cutting head rotates at a high velocity, the additional weight causes the cutting head to be out of balance and creates vibration in the cutting head. This translates into vibration in the razor head and screen and improves cutting efficiency.

In accordance with another aspect of the invention, the cutting head itself may be made in an unbalanced configuration, such as, for example, by using a larger or smaller amount of material on one portion of the cutting head than on radially similar positions. The uneven weight distribution of the cutting head will cause the cutting head to vibrate as it rotates about the shaft from the electric motor.

### BRIEF DESCRIPTION OF THE DRAWINGS

The above and other objects, features and advantages of the invention will become apparent from a consideration of the following detailed description presented in connection with the accompanying drawings in which:

FIG. 1 shows a partially cut-away view of a conventional electric razor having a rotating cutting head;

FIG. 2 shows a perspective view of a cutting head according to the present invention with an attached weight;

FIG. 3 shows a top view of a cutting head configured in accordance with one aspect of the present invention;

FIG. 4 shows a top view of a cutting head made in accordance with another aspect of the present invention;

FIG. 5 shows a cross-sectional view of an attachment for the razor of FIG. 1;

FIG. 6 shows a cross-sectional view of an alternate configuration of the attachment of FIG. 5; and

FIG. 7 shows a partially cut away side view of a razor with the attachment of FIG. 5 or FIG. 6.

### DETAILED DESCRIPTION

The present invention will now be discussed with respect to the appended drawings so as to enable one of ordinary skill in the art to make and use the invention. It will be appreciated that the description below is only exemplary of the invention and is not intended to limit the scope of the appended claims. Furthermore, it will be appreciated that any one embodiment of the invention need not contain each and every object of the invention and that various aspects of the invention may be shown in different drawings for convenience and clarity, but may be used together in a practical implementation of the invention.

Turning now to FIG. 2 there is show a perspective view of a cutting head 22 according to the present invention. The cutting head 22 includes a plurality of blades 20 which are disposed to cut when rotated about the shaft 28 which extends from the electric motor. Thus, the shaft 28 forms the axis about which the blades rotate. The blades 20 are evenly spaced around the cutting head 22. A plurality of flanges 24 extend from the surface of the cutting head 22 to provide a mounting surface for the plurality of blades 20.

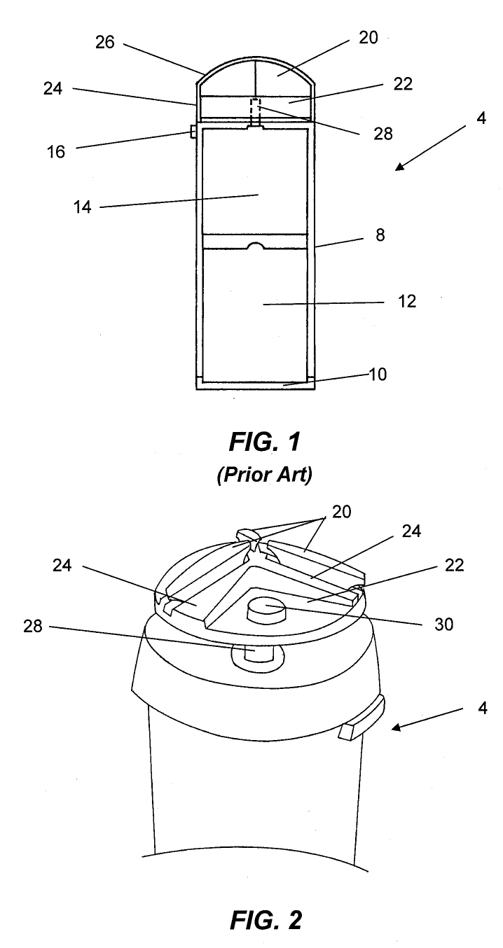

Also disposed on the cutting head 22 is a weight 30. The weight 30 may be formed from a variety of substances, such as a small screw head, a dot of metal, plastic, or some other material which provides sufficient weight such that when the cutting head is spun at a high revolution rate, the weight causes vibration in the cutting head 22. It will be appreciated that the further the weight is from the center axis of rotation (i.e. the middle of the shaft 28) the less weight will be required to produce the desired vibration. The weight 30 causes the entire electric shaver head to vibrate as it is cutting, thereby causing the screen 26 (as shown in FIG. 1) to move. Typically the movement will be in very small circles. This results in improved performance as the hairs which are extending outwardly from the skin at a variety of angles are better pushed through the screen 26 by the vibrational motion caused by the weight 30.

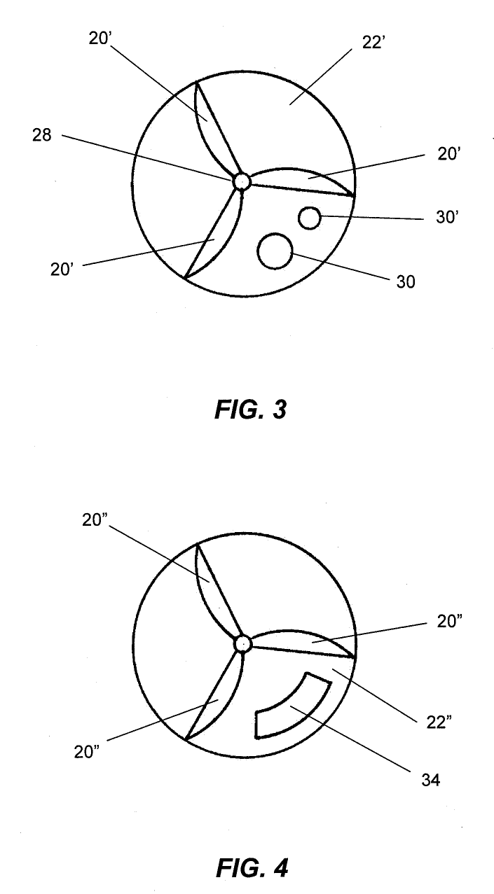

Turning now to FIG. 3 there is shown a top schematic view of the cutting head 22′. It will be appreciated that while one weight works well, that a plurality of weights such as 30 and 30′ can also be used. For example, placing weights on two parts of the cutting head can also create vibrational energy in the cutting head thus creating the desired motion in the screen 26. It will be appreciated that if multiple weights 30, 30′ are used, the weights should not be placed such that they result in a balanced cutting head 22 which does not produce any vibration.

Turning now to FIG. 4 there is shown a schematic view illustrating an alternate configuration of a cutting head 22″ in accordance with the present invention. Rather than using a weight, such as weight 30 to create the vibrational energy, the cutting head 22″ is configured so that a greater or lesser amount (weight) of material, indicated at 34, is disposed at one radial location (i.e. a point at a given distance from the axis of rotation) than at radially similar locations about the cutting head. Alternatively, the cutting head 22″ can be constructed so that at least one flange 24 (such as is shown in FIG. 2) is smaller or larger than other flanges 24 on the cutting head 22″ thereby creating an unbalanced cutting head.

The unbalanced weight in the cutting head 22″ created by the additional material, causes generally circular vibrational energy in the cutting head when the cutting head is rotated at a high RPMs. This in turn causes generally circular vibrations in the head of the shaver thereby improving cutting as the electric shaver is moved.

In light of the present disclosure, it will be appreciated that there are multiple ways of creating a cutting head which is sufficiently unbalanced to create generally circular vibrating movement in the screen of the razor. Such might include removing portions of the conventional cutting head so that the weight is distributed unevenly. Likewise, changes in the shape could also be used to this end.

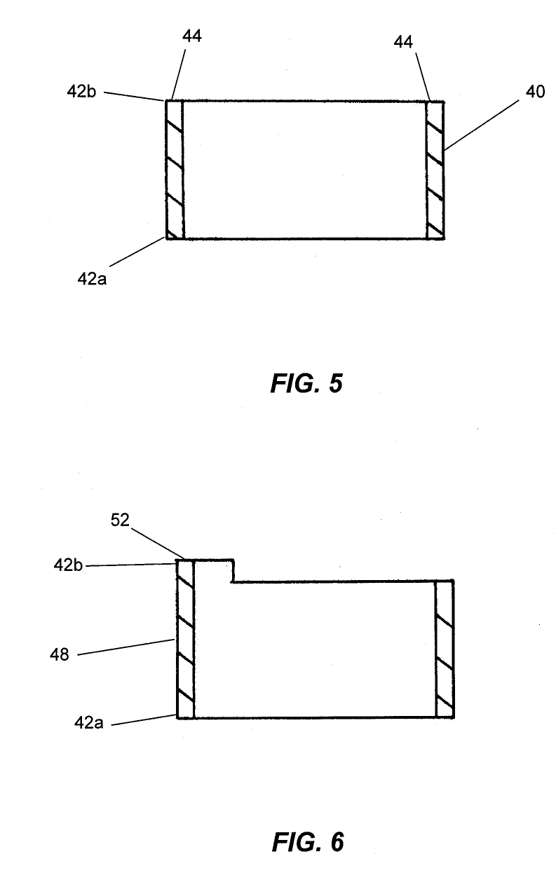

Turning now to FIG. 5 there is shown an attachment 40 for the razor 4 shown in FIG. 1. The attachment 40 is generally cylindrical and mounts on the cap 24. The attachment 40 has one end 42a which is configured to engage the cap 24 and a second end 42b which is configured to provide an edge 44 disposed slightly above at least a portion of the screen 26. One problem with electric razors is that they have a hard time cutting longer hair or hair which is curled or laying adjacent the skin. As the razor 4 and the attachment 40 are passed over the skin, the edge 44 engages the hair and encourages it to stand more vertically. This allows the hair to be more completely drawn through the screen 26 and to be cut by the cutting blades 20.

The edge 44 can either be sufficiently sharp to engage the hair, or it can be made from a high friction material, such as rubber or silicone, so that it will engage and lift the hair shortly before it engages the razor. Either way, the hair will stand more vertically and the ability of the razor to cut the hair will be increased.

FIG. 6 shows another attachment 48 for the razor 4. The attachment 48 is similar to attachment 40, except that the edge 52 does not extend all of the way around the circular opening at the top of the attachment. Rather, the raised portion of the edge 52 may extend to a limited extent around the opening, such as between 120 and 180 degrees around the opening. This configuration may be preferred by someone who prefers to move the razor unidirectionally while shaving, whereas the configuration in FIG. 5 may be preferred by one who likes to move the electric razor in a circular motion while shaving.

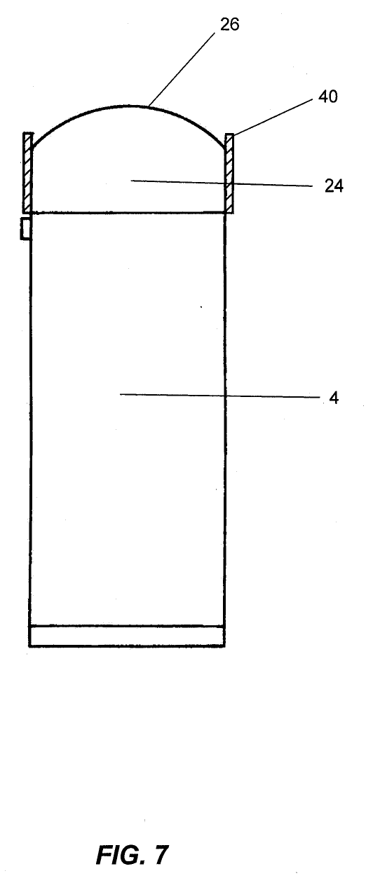

Turning now to FIG. 7, a partially cut away side view of a razor having the attachment of FIG. 5 or 6 is shown. The attachment 40 (although attachment 48 is similarly used) has been placed over the cap 24 of the razor 4. The attachment 40 is held onto the cap 24 by friction, and extends beyond the cap as shown. As discussed, the attachment helps to lift the hair and place the hair in a position where it is more effectively cut by the razor 4.

Thus there is disclosed an improved method and apparatus for shaving. Those skilled in the art will appreciate that numerous modifications can be made without departing from the scope and spirit of the present invention. The appended claims are intended to cover such improvements.

What is claimed is:

1. An electric razor having:
a cutting head having at least one cutting blade disposed thereon and having an axis of rotation,
a screen disposed adjacent the at least one blade of the cutting head;
a motor configured for rotating the cutting head about said axis so as to cut hair which passes through the screen; and
wherein the cutting head is unbalanced so as to create generally circular vibrational motion when the cutting head is rotated about said axis.

2. The electric razor of claim 1, wherein the cutting head is generally circular and a weight is attached to the cutting head radially outwardly from a center of rotation such that the cutting head is unbalanced.

3. The electric razor of claim 1, wherein the cutting head is formed such that the cutting head is not symmetric about said axis such that the cutting head is unbalanced.

4. The electric razor of claim 1, wherein the cutting head comprises a plurality of cutting blades disposed symmetrically about said axis.

5. The electric razor of claim 1, wherein the cutting head has an amount of material at a first radial location that causes the weight at said first radial location to be greater than the weight at other like radial locations so as to create an unbalanced cutting head.

6. The electric razor of claim 1, wherein the cutting head has an amount of material removed at a first radial location that causes the weight at said first radial location to be less than the weight at other like radial locations so as to create an unbalanced cutting head.

7. The electric razor of claim 1, wherein the electric razor consists of a single cutting head having a plurality of blades thereon, all of the blades rotating about a common axis.

8. The electric razor of claim 1, further comprising a generally cylindrical attachment, the attachment having an open first end mounted about the cutting end of the razor and an open second end for engaging skin of a user while using the razor.

9. The electric razor of claim 8, wherein the open second end is sufficiently sharp to engage the hair on the skin of a user.

10. The electric razor of claim 8, wherein the open second end is comprises a high friction material to engage the hair on the skin of a user.

11. The electric razor of claim 10, wherein the high friction material is rubber or silicone.

12. The electric razor of claim 8, wherein the open second end comprises a ridge extending partially around the opening for engaging hair of a user.

13. A method for improving the cutting of an electric razor, the method comprising:
selecting an electric razor having a cutting head with at least one blade disposed to rotate about a center axis of the cutting head; and
adding weight to or removing weight from to the cutting head to make the cutting head unbalanced as it rotates about the center axis to thereby create generally circular vibrational motion.

14. The method according to claim 13, where the method comprises selecting an electric razor having a single cutting head.

15. The method according to claim 13, further comprising disposing a generally cylindrical attachment adjacent the cutting head to lift hair prior to cutting.

16. The method according to claim 15, wherein the generally cylindrical attachment is sufficiently sharp to engage hair on the skin of a user.

17. The method according to claim 15, wherein the generally cylindrical attachment has a ridge that extends at least partially around one edge of the cylindrical attachment.

18. The method according to claim 15, wherein the generally cylindrical attachment is formed of a high friction material.

19. The method according to claim 13, wherein the method comprises forming the cutting head with a greater amount of material at one radial location than at other like radial locations to cause the cutting head to be unbalanced.

20. The method according to claim 13, wherein the method comprises forming the cutting head with a lesser amount of material at one radial location than at other like radial locations to cause the cutting head to be unbalanced.

21. The method according to claim 13, wherein the method comprises attaching at least one weight to the cutting head.
